(19) United States
(12) Patent Application Publication
(10) Pub. No.: US 2020/0099104 A1
(43) Pub. Date: Mar. 26, 2020

(54) LITHIUM SECONDARY BATTERY

(71) Applicant: TOYOTA JIDOSHA KABUSHIKI KAISHA, Toyota-shi (JP)

(72) Inventors: Masaki WATANABE, Sunto-gun (JP); Masafumi NOSE, Susono-shi (JP)

(73) Assignee: TOYOTA JIDOSHA KABUSHIKI KAISHA, Toyota-shi (JP)

(21) Appl. No.: 16/527,906

(22) Filed: Jul. 31, 2019

(30) Foreign Application Priority Data
Sep. 25, 2018 (JP) 2018-179501

(51) Int. Cl. H01M 10/0585; H01M 4/38; H01M 10/056; H01M 10/052

(52) U.S. Cl. CPC H01M 10/0585; H01M 4/382; H01M 10/056; H01M 2300/0094; H01M 2300/0071; H01M 2300/0028; H01M 10/052

(57) ABSTRACT

There is provided a lithium secondary battery containing lithium metal as the negative electrode active material, which can inhibit reduction in charge-discharge capacity while also minimizing internal short circuiting. The lithium secondary battery of the disclosure has a construction with a positive electrode active material layer, a separator layer and a negative electrode active material layer laminated in that order, wherein the negative electrode active material layer comprises lithium metal, the separator layer has a shut layer and one or more solid electrolyte layers, one of the solid electrolyte layers is adjacent to the negative electrode active material layer, and the shut layer comprises a lithium ion conductive liquid that reacts with the lithium metal to produce an electronic insulator.

### FIELD

The present disclosure relates to a lithium secondary battery.

### BACKGROUND

Lithium secondary batteries have the feature of higher energy density than other types of secondary batteries, as well as the ability to operate at high voltage. They are therefore used in data devices such as cellular phones as secondary batteries that can be easily made small and lightweight, and they are in increasing demand in recent years for generation of large mechanical power in electric vehicles, hybrid vehicles and the like.

Repeated charge-discharge of a lithium secondary battery is known to lead to growth of dendrites of lithium metal in the negative electrode active material layer, which reach to the positive electrode active material layer and often result in internal short circuiting, depending on the construction of the battery and the mode in which it is used.

Internal short circuiting caused by growth of lithium metal dendrites is not limited to nonaqueous lithium secondary batteries, but is known to occur with all-solid lithium secondary batteries as well.

NPL 1, for example, discloses an all-solid lithium secondary battery wherein growth of lithium metal dendrites sometimes occurs in the regions of relatively low strength such as minute defects or grain boundaries present in the solid electrolyte layer, and wherein lithium metal dendrites that have grown in the solid electrolyte layer extend to the positive electrode active material layer side upon penetrating through the solid electrolyte layer.

Technology for solving the problem of internal short circuiting caused by growth of lithium metal dendrites is disclosed in PTLs 1 to 3.

PTL 1 discloses an all-solid lithium secondary battery having a liquid substance that reacts with lithium metal to produce an electronic insulator, present in a powder-molded solid electrolyte layer formed by molding a solid electrolyte powder. The same publication states that if the all-solid lithium secondary battery has such a construction, then even if the lithium metal dendrites have grown through gaps between the powder of the solid electrolyte layer, the lithium metal and liquid substances react causing the lithium metal to become an electronic insulator, thus allowing internal short circuiting of the battery to be reliably prevented.

PTL 2 discloses an all-solid lithium secondary battery comprising a powder-molded section where powder of a first solid electrolyte is molded, and a surface vapor deposited film formed by accumulating a second solid electrolyte on the surface of either or both the positive electrode active material layer side and negative electrode active material layer side, by a gas phase method. The same publication states that since the all-solid lithium secondary battery having such a construction comprises a surface vapor deposited film in the solid electrolyte layer, growth of lithium metal dendrites can be inhibited so that internal short circuiting of the battery can be prevented.

PTL 3 discloses an electrolyte solution for a lithium secondary battery, wherein the lithium salt concentration in the electrolyte solution is 0.37 to 0.75 mol/kg. The same publication states that a solution-type lithium secondary battery having an electrolyte solution with this construction can sufficiently supply lithium ions near the negative electrode active material layer during charge, and as a result, lithium metal dendrite generation caused primarily by lithium ion deficiency can be inhibited.

Techniques using ionic liquids for lithium secondary batteries are disclosed in PTLs 4 to 6, for example.

PTL 4 relates to a predoping technique that inhibits irreversible capacity of the negative electrode active material by doping the negative electrode active material of the lithium secondary battery with lithium ions beforehand. The same publication discloses stabilized lithium powder having a coating film on the surfaces of lithium particles, there being contained in the coating film a lithium salt with an anion that allows formation of an ionic liquid. The same publication also states that using stabilized lithium powder having such a construction can yield a lithium secondary battery with high battery characteristics.

PTL 5 discloses a non-aqueous electrolyte battery comprising a negative electrode active material and a positive electrode active material either containing or occluding and releasing lithium, a separator, and an ionic liquid containing a lithium salt.

PTL 6 discloses a positive electrode mixture for a lithium sulfur solid-state battery, containing sulfur, a conductive support, a binder and an ionic liquid or solvated ionic liquid. The same publication states that using a positive electrode mixture with such a construction in a lithium sulfur solid-state battery reduces the interface resistance between the solid electrolyte and positive electrode active material.

### CITATION LIST

### Patent Literature

[PTL 1] Japanese Unexamined Patent Publication No. 2009-211910
[PTL 2] Japanese Unexamined Patent Publication No. 2009-301959
[PTL 3] Japanese Unexamined Patent Publication No. 2012-113929
[PTL 4] Japanese Unexamined Patent Publication No. 2016-76334
[PTL 5] Japanese Unexamined Patent Publication No. 2007-323837
[PTL 6] Japanese Unexamined Patent Publication No. 2017-168435

### Non Patent Literature

[NPL 1] Cheng et al, Electrochimica Acta, 223 (2017) 85-91

### SUMMARY

### Technical Problem

Repeated charge-discharge of a lithium secondary battery is known to cause growth of lithium metal dendrites from the negative electrode active material layer that contact with the positive electrode active material layer, thus potentially causing internal short circuiting.

One of the causes of growth of lithium metal dendrites inside lithium secondary batteries is excessive current during charge, for example.

In a lithium secondary battery using lithium metal as the negative electrode active material, highly repetitive charge-discharge may result in non-uniform deposition of lithium metal on the negative electrode active material layer side, producing local regions with excessive current density during charge. It is thought that deposition of lithium metal occurs more readily in such regions than in other regions, with these regions tending to act as origins for growth of lithium metal dendrites.

One possible method for suppressing internal short circuiting caused by growth of lithium metal dendrites in a lithium secondary battery, for a lithium secondary battery having a solid electrolyte layer between the positive electrode active material layer and the negative electrode active material layer, for example, is to add a liquid substance to the solid electrolyte layer which reacts with the lithium metal to produce an electronic insulator, as in PTL 1.

However, the present inventors have found that when the method of PTL 1 is used for a lithium secondary battery containing a lithium metal as the negative electrode active material, the lithium metal serving as the negative electrode active material reacts with the liquid substance at the interface between the solid electrolyte layer and negative electrode active material layer, becoming inactivated, and often lowering the charge-discharge capacity.

It is an object of the present disclosure to provide a lithium secondary battery containing lithium metal as the negative electrode active material, which can inhibit reduction in charge-discharge capacity while also minimizing internal short circuiting.

### Solution to Problem

The present inventors have found that the aforementioned object can be achieved by the means described below.

### <Aspect 1>

A lithium secondary battery having a construction with a positive electrode active material layer, a separator layer and a negative electrode active material layer laminated in that order, wherein

the negative electrode active material layer comprises lithium metal,

the separator layer has a shut layer and one or more solid electrolyte layers, one of the solid electrolyte layers is adjacent to the negative electrode active material layer, and

the shut layer comprises a lithium ion conductive liquid that reacts with the lithium metal to produce an electronic insulator.

### <Aspect 2>

The lithium secondary battery according to aspect 1, wherein the lithium ion conductive liquid in the shut layer is supported on a porous film.

### <Aspect 3>

The lithium secondary battery according to aspect 1 or 2, wherein the lithium ion conductive liquid in the shut layer is in a gel state.

### <Aspect 4>

The lithium secondary battery according to any one of aspects 1 to 3, wherein the LUMO of the lithium ion conductive liquid is no greater than −0.50 eV.

### <Aspect 5>

The lithium secondary battery according to any one of aspects 1 to 4, wherein the lithium ion conductive liquid comprises an ionic liquid.

### <Aspect 6>

The lithium secondary battery according to aspect 5, wherein a lithium salt is dissolved in the ionic liquid.

### <Aspect 7>

The lithium secondary battery according to aspect 5 or 6, wherein the ionic liquid is N-methyl-N-propylpiperidinium bis(trifluoromethanesulfonyl)imide, butyltrimethylammonium bis(trifluoromethanesulfonyl)imide, N,N-diethyl-N-methyl-N-(2-methoxyethyl)ammonium bis(trifluoromethanesulfonyl)imide, 1-allyl-3-methylimidazolium bis(trifluoromethylsulfonyl)imide, triethylpentylphosphonium bistrifluoromethanesulfonylimide, 1-allyl-3-ethylimidazolium bis(trifluoromethanesulfonyl)imide, 1-allyl-3-butylimidazolium bis(trifluoromethanesulfonyl)imide, 1,3-diallylimidazolium bis(trifluoromethanesulfonyl)imide, 1-methyl-3-propylimidazolium bis(trifluoromethanesulfonyl)imide or a combination thereof.

### <Aspect 8>

The lithium secondary battery according to any one of aspects 1 to 7, wherein the denseness of the solid electrolyte layer is 97% or greater.

### <Aspect 9>

The lithium secondary battery according to any one of aspects 1 to 8, wherein the solid electrolyte layer comprises a sintered oxide solid electrolyte.

### <Aspect 10>

The lithium secondary battery according to any one of aspects 1 to 9, wherein the positive electrode active material layer and/or the solid electrolyte layer comprises a sulfide solid electrolyte.

### <Aspect 11>

The lithium secondary battery according to any one of aspects 1 to 10, wherein the positive electrode active material layer comprises sulfur as a positive electrode active material.

### Advantageous Effects of Invention

The present disclosure can provide a lithium secondary battery containing lithium metal as the negative electrode active material, which can inhibit reduction in charge-discharge capacity while also minimizing internal short circuiting.

### BRIEF DESCRIPTION OF DRAWINGS

FIG. 1 is a schematic diagram of one embodiment of the lithium secondary battery of the disclosure.

FIG. 2 is a schematic diagram showing an example of a different lithium secondary battery according to the disclosure.

FIG. 3 is a graph showing the charge-discharge capacities of the lithium secondary batteries of Example 1 and Comparative Example 1.

### DESCRIPTION OF EMBODIMENTS

Embodiments of the disclosure will now be explained in detail. The disclosure is not limited to the embodiments described below, however, and various modifications may be implemented within the scope of the gist thereof.

### <Lithium Secondary Battery>

The lithium secondary battery of the disclosure has a construction with a positive electrode active material layer, a separator layer and a negative electrode active material layer laminated in that order, wherein the negative electrode active material layer comprises lithium metal, the separator layer has a shut layer and one or more solid electrolyte layers, one of the solid electrolyte layers is adjacent to the negative electrode active material layer, and the shut layer comprises a lithium ion conductive liquid that reacts with the lithium metal to produce an electronic insulator.

The lithium secondary battery of the disclosure may have a structure with, for example, a positive electrode collector layer, a positive electrode active material layer, a separator layer, a negative electrode active material layer and a negative electrode collector layer in that order.

The positive electrode active material layer and/or solid electrolyte layer in the lithium secondary battery of the disclosure may also contain a sulfide solid electrolyte.

Without being restricted to any particular principle, it is believed that the principle by which a lithium secondary battery having the construction of the disclosure inhibits reduction in charge-discharge capacity while also minimizing internal short circuiting, may be the following.

Repeated charge-discharge of a lithium secondary battery is known to cause growth of lithium metal dendrites from the negative electrode active material layer that contact with the positive electrode active material layer, thus potentially causing internal short circuiting.

Even with a lithium secondary battery having the construction of the disclosure, repeated charge-discharge is thought to often lead to growth of lithium metal dendrites from the negative electrode active material layer toward the positive electrode active material layer side.

In the lithium secondary battery of the disclosure, however, the shut layer comprises a lithium ion conductive liquid that reacts with the lithium metal to produce an electronic insulator. Consequently, even if lithium metal dendrites have grown from the negative electrode active material layer toward the positive electrode active material layer side with repeated charge-discharge, when the lithium metal dendrites that have grown from the negative electrode active material layer through the interior of the solid electrolyte layer reach the shut layer, the lithium metal dendrites react with the lithium ion conductive liquid producing an electronic insulator, so that any further growth is inhibited.

In the lithium secondary battery having the construction of the disclosure, therefore, the lithium metal dendrites do not grow enough to reach the positive electrode active material layer, thus helping to inhibit internal short circuiting caused by growth of lithium metal dendrites.

In addition, the lithium secondary battery having the construction of the disclosure has a solid electrolyte layer between the shut layer and the negative electrode active material layer. This can therefore inhibit contact of the lithium ion conductive liquid in the shut layer, that reacts with the lithium metal to produce the electronic insulator, with the lithium metal of the negative electrode active material layer. It is thus possible to inhibit inactivation of the lithium metal in the negative electrode active material layer, thus allowing reduction in the charge-discharge capacity of the battery to be inhibited.

The principle by which a lithium secondary battery having the construction of the disclosure can inhibit reduction in charge-discharge capacity while minimizing internal short circuiting will now be explained in detail using embodiments of the lithium secondary battery of the disclosure and an example of a lithium secondary battery that is different from the disclosure.

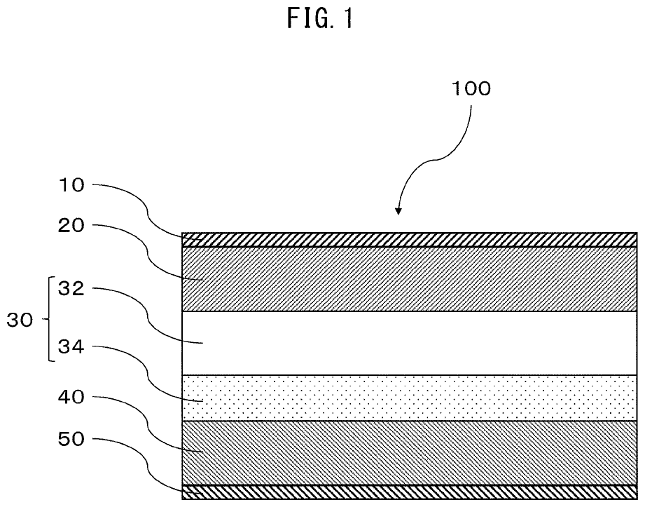

FIG. 1 is a schematic diagram of one embodiment of the lithium secondary battery of the disclosure. According to one embodiment of the lithium secondary battery of the disclosure, as shown in FIG. 1, the lithium secondary battery 100 has a structure with a positive electrode collector layer 10, a positive electrode active material layer 20, a separator layer 30, a negative electrode active material layer 40 and a negative electrode collector layer 50, laminated in that order. The negative electrode active material layer 40 comprises lithium metal. The separator layer 30 comprises a shut layer 32 and a solid electrolyte layer 34. The solid electrolyte layer 34 is adjacent to the negative electrode active material layer 40. The shut layer 32 further comprises a lithium ion conductive liquid that reacts with the lithium metal to produce an electronic insulator.

As shown in FIG. 1, the lithium secondary battery of one embodiment of the lithium secondary battery of the disclosure has a shut layer 32 between the positive electrode active material layer 20 and the negative electrode active material layer 40, containing a lithium ion conductive liquid that reacts with the lithium metal to produce an electronic insulator. Consequently, when lithium metal dendrites have grown from the negative electrode active material layer 40 side toward the positive electrode active material layer 20 side with repeated charge-discharge of the lithium secondary battery, the lithium metal dendrites react with the lithium ion conductive liquid of the shut layer 32, forming an electronic insulator. Further growth of the lithium metal dendrites is thus inhibited.

Moreover, as shown in FIG. 1, a solid electrolyte layer 34 is present between the negative electrode active material layer 40 and the shut layer 32 in the lithium secondary battery of one embodiment of the lithium secondary battery of the disclosure. This can inhibit the lithium ion conductive liquid in the shut layer 32 from contacting the negative electrode active material layer 40.

FIG. 1 is not intended to limit the aspects of the lithium secondary battery of the disclosure, incidentally.

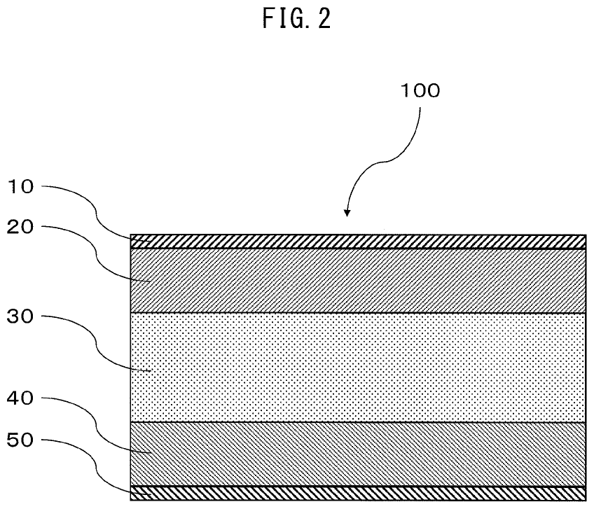

FIG. 2 is a schematic diagram showing an example of different lithium secondary battery according to the disclosure. In this different example of a lithium secondary battery different of the disclosure, as shown in FIG. 2, the lithium secondary battery 100 has a structure with a positive electrode collector layer 10, a positive electrode active material layer 20, a separator layer 30, a negative electrode active material layer 40 and a negative electrode collector layer 50, laminated in that order. The separator layer 30 has a structure wherein a layer comprising a solid electrolyte is impregnated with a lithium ion conductive liquid that reacts with the lithium metal to produce an electronic insulator.

The lithium secondary battery shown in FIG. 2 has a separator layer 30 between the positive electrode active material layer 20 and the negative electrode active material layer 40, containing a lithium ion conductive liquid that reacts with the lithium metal to produce an electronic insulator. Consequently, when lithium metal dendrites have grown from the negative electrode active material layer 40 side toward the positive electrode active material layer 20 side with repeated charge-discharge of the lithium secondary battery, the lithium metal dendrites react with the lithium ion conductive liquid of the separator layer 30, forming an electronic insulator. This can inhibit further growth of the lithium metal dendrites.

However, in this different example of the lithium secondary battery of the disclosure, shown in FIG. 2, the separator layer 30 has structure with a lithium ion conductive liquid impregnated in a layer comprising a solid electrolyte, and therefore the lithium ion conductive liquid is in contact with the negative electrode active material layer 40. In this different example of the lithium secondary battery of the disclosure, therefore, especially when the negative electrode active material layer 40 comprises lithium metal, the lithium metal of the negative electrode active material layer 40 often contacts with the lithium ion conductive liquid in the separator layer 30, becoming inactivated. Inactivation of the lithium metal often leads to lower charge-discharge capacity of the battery.

### <Separator Layer>

The lithium secondary battery of the disclosure has a separator layer between the positive electrode active material layer and the negative electrode active material layer. The separator layer also has a shut layer and one or more solid electrolyte layers.

The separator layer may have a solid electrolyte layer, a shut layer and an another solid electrolyte layer in that order from the negative electrode active material layer side, or in other words, it may have a structure with the shut layer sandwiched between two solid electrolyte layers.

### <Shut Layer>

The shut layer comprises a lithium ion conductive liquid that reacts with the lithium metal to produce an electronic insulator. When lithium metal dendrites have grown from the negative electrode active material layer side toward the positive electrode active material layer side with repeated charge-discharge of the lithium secondary battery of the disclosure, the lithium metal dendrites reach the shut layer, whereupon the lithium ion conductive liquid in the shut layer react with the lithium metal dendrites producing an electronic insulator. Since this inhibits further growth of the lithium metal dendrites, internal short circuiting caused by growth of lithium metal dendrites can be inhibited.

The lithium ion conductive liquid may be held in a porous film in the shut layer. The porous film is not limited so long as it can hold the lithium ion conductive liquid. The lithium ion conductive liquid may be held in the porous film in a manner such that the lithium ion conductive liquid is impregnated in the porous film, for example.

The porous film may be a porous film commonly used as a separator for lithium secondary batteries, such as a nonwoven fabric, woven fabric or sintered material, for example. More specifically, a thin microporous film of an olefin-based resin such as polyethylene or polypropylene, a polymer nonwoven fabric such as a polypropylene nonwoven fabric or polyphenylene sulfide nonwoven fabric, or sintered material made by sintering solid electrolyte particles to be subsequently described, may be used.

The lithium ion conductive liquid that produces an electronic insulator by reaction with lithium metal in the shut layer may be contained in a gel state. The lithium ion conductive liquid may be contained in a gel state in a manner with a polymer dispersed in the lithium ion conductive liquid, for example. When the lithium ion conductive liquid is contained in the shut layer in a gel state, the lithium ion conductive liquid may be either held or not held in the porous film.

The lithium ion conductive liquid that produces the electronic insulator by reaction with the lithium metal is not particularly restricted so long as it can be used in a lithium secondary battery.

The liquid may be a substance having a Lowest Unoccupied Molecular Orbital (LUMO) of −0.50 eV or less. This is because a substance with a low LUMO has low reduction resistance, and therefore its contact with a lithium metal reducing agent causes the liquid to react with the lithium metal, tending to produce an electronic insulator on the surface of the lithium metal. The LUMO of the liquid may be −0.50 eV or less, −0.80 eV or less, −1.00 eV or less, −1.50 eV or less, −2.00 eV or less or −2.20 eV or less, and −4.00 eV or greater, −3.50 eV or greater, −3.00 eV or greater, −2.50 eV or greater, −2.30 eV or greater or −2.20 eV or greater.

The lithium ion conductive liquid that reacts with the lithium metal to produce an electronic insulator may contain an ionic liquid, for example, with a lithium salt dissolved in the ionic liquid.

The ionic liquid may be, but is not limited to, N-methyl-N-propylpiperidinium bis(trifluoromethanesulfonyl)imide (PP13TFSI), butyltrimethylammonium bis(trifluoromethanesulfonyl)imide (BTMATFSI), N,N-diethyl-N-methyl-N-(2-methoxyethyl)ammonium bis(trifluoromethanesulfonyl)imide (DEMETFSI), 1-allyl-3-methylimidazolium bis(trifluoromethylsulfonyl)imide (AMIMTFSI), triethylpentylphosphonium bistrifluoromethanesulfonylimide (P2225TFSI), 1-allyl-3-ethylimidazolium bis(trifluoromethanesulfonyl)imide (AEIMTFSI), 1-allyl-3-butylimidazolium bis(trifluoromethanesulfonyl)imide (ABIMTFSI), 1,3-diallylimidazolium bis(trifluoromethanesulfonyl)imide (AAIMTFSI), 1-methyl-3-propylimidazolium bis(trifluoromethanesulfonyl)imide (MPIMTFSI), and combinations thereof.

When the positive electrode active material layer and/or the solid electrolyte layer comprises a sulfide solid electrolyte, the ionic liquid is preferably N-methyl-N-propylpiperidinium bis(trifluoromethanesulfonyl)imide or 1-allyl-3-methylimidazolium bis(trifluoromethylsulfonyl)imide. These ionic liquids have low reactivity with sulfide solid electrolytes.

The lithium salt is not particularly restricted so long as it can be used as an electrolyte component in a lithium secondary battery. The lithium salt may be a salt of lithium with the anion of the ionic liquid, such as lithium bis(trifluoromethanesulfonyl)imide (LiTFSI), for example.

### <Solid Electrolyte Layer>

One of the solid electrolyte layers of the lithium secondary battery of the disclosure is adjacent to the negative electrode active material layer.

The solid electrolyte layer of the lithium secondary battery of the disclosure may also include a solid electrolyte and an optional binder. The solid electrolyte used is not particularly restricted, and it may be any material that can be used as a solid electrolyte for an all-solid-state battery. For example, the solid electrolyte may be, though it is not limited to, a crystalline or amorphous sulfide solid electrolyte, or a crystalline or amorphous oxide solid electrolyte. The solid electrolyte may be in the form of a powder or a sintered material. Since glass in the sintered solid electrolyte seals the pores near the surface of the sintered solid electrolyte, this makes it possible to reduce through-holes in the solid electrolyte. The sintered solid electrolyte may be a sintered oxide solid electrolyte.

Examples for the sulfide solid electrolyte include, but are not limited to, sulfide-based amorphous solid electrolytes, sulfide-based crystalline solid electrolytes and argyrodite solid electrolytes. Specific examples of sulfide solid electrolytes include, but are not limited to, Li₂S—P₂S₅-based sulfide solid electrolyte (Li₇P₃S₁₁, Li₃PS₄, Li₈P₂S₉, etc.), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂, etc.), LiI—Li₂S—P₂O₅, LiI—Li₃PO₄—P₂S₅ and Li₇₋ₓPS₆₋ₓClₓ, or combinations thereof.

Examples of oxide solid electrolytes include, but are not limited to, Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄ and Li₃₊ₓPO₄₋ₓNₓ(LiPON) etc.

The solid electrolyte may be glass or crystallized glass (glass ceramic). The solid electrolyte layer may include a binder or the like if necessary, in addition to the solid electrolyte mentioned above. Specific examples are the same as for the “binder” mentioned below for the “positive electrode active material layer”.

The lithium secondary battery of the disclosure may have a denseness of 97% or greater for the solid electrolyte layer. Here “denseness” is an index of the lack of voids in the solid electrolyte layer, and specifically, it can be calculated by measuring the weight and volume of the solid electrolyte layer, calculating the density, and dividing the calculated density by the true density.

The denseness of the solid electrolyte layer may be 90% or greater, 92% or greater, 95% or greater, 97% or greater or 99% or greater, for example. With high denseness of the solid electrolyte layer, it is easier to prevent the liquid contained in the shut layer, that has lithium ion conductivity and reacts with the lithium metal to produce an electronic insulator, from contacting with the negative electrode active material layer side through the solid electrolyte layer.

### <Negative Electrode Active Material Layer>

The negative electrode active material layer of the lithium secondary battery of the disclosure is a layer containing lithium metal as a negative electrode active material. There are no particular restrictions on the form of the lithium metal in the negative electrode active material layer, and it may be a lithium metal foil, for example.

### <Positive Electrode Active Material Layer>

The positive electrode active material layer comprises at least a positive electrode active material, and preferably it further comprises the solid electrolyte mentioned for the solid electrolyte layer. In addition, it may include additives used in positive electrode active material layers for all-solid-state batteries, such as conductive aids and binders, for example, depending on the application and the purpose of use.

The material of the positive electrode active material is not particularly restricted. For example, the positive electrode active material may be, but is not limited to, heterogenous element-substituted Li—Mn spinel having a composition represented by lithium cobaltate (LiCoO₂), lithium nickelate (LiNiO₂), lithium manganate (LiMn₂O₄), LiCo_{1/3}Ni_{1/3}Mn_{1/3}O₂ and Li₁₊ₓMn_{2-x-y}M_{y}O₄ (where M is one or more metal elements selected from among Al, Mg, Co, Fe, Ni and Zn).

The lithium secondary battery of the disclosure may also comprise sulfur as a positive electrode active material. The lithium secondary battery containing sulfur as a positive electrode active material may be any of those referred to as lithium sulfur secondary batteries by those skilled in the art.

The conductive aid is not particularly restricted. For example, the conductive aid may be, but is not limited to, a carbon material such as VGCF (Vapor Grown Carbon Fibers) or carbon nanofibers, or a metal material.

The binder is also not particularly restricted. For example, the binder may be, but is not limited to, a material such as polyvinylidene fluoride (PVdF), carboxymethyl cellulose (CMC), butadiene rubber (BR) or styrene-butadiene rubber (SBR), or a combination thereof.

### <Positive Electrode Collector Layer and Negative Electrode Collector Layer>

The lithium secondary battery of the disclosure may have a structure with, for example, a positive electrode collector layer, a positive electrode active material layer, a separator layer, a negative electrode active material layer and a negative electrode collector layer in that order.

### <Positive Electrode Collector Layer>

The material used in the positive electrode collector layer is not particularly restricted, and any one that can be used in an all-solid-state battery may be employed as appropriate. For example, the material used in the positive electrode collector layer may be, but is not limited to, stainless steel (SUS), aluminum, copper, nickel, iron, titanium or carbon.

The form of the positive electrode collector layer is not particularly restricted and may be, for example, a foil, sheet, mesh, or the like. A foil is preferred among these.

### <Negative Electrode Collector Layer>

The material used in the negative electrode collector layer is not particularly restricted, and any one that can be used in an all-solid-state battery may be employed as appropriate. For example, the material used in the negative electrode collector layer may be, but is not limited to, SUS, aluminum, copper, nickel, iron, titanium or carbon.

The form of the negative electrode collector layer is not particularly restricted and may be, for example, a foil, sheet, mesh, or the like. A foil is preferred among these.

### EXAMPLES

### Example 1 and Comparative Example 1

Lithium sulfur secondary batteries for Example 1 and Comparative Example 1 were prepared in the following manner, and their performance was compared.

### Example 1

### Preparation of Shut Layer

A separator containing an ionic liquid was prepared as a shut layer, in the following manner. A lithium salt was dissolved in the ionic liquid.

A solution of N-methyl-N-propylpiperidinium bis(trifluoromethanesulfonyl)imide (PP13TFSI) containing 0.4 mol/L lithium bis(trifluoromethanesulfonyl)imide (LiTFSI) was prepared as an ionic liquid dissolving a lithium salt. A nonwoven fabric separator was immersed in the solution for 1 minute under a pressure of 10 Pa for vacuum impregnation. The separator was then removed from the solution and the excess liquid on the separator was wiped off with a wipe cloth.

### Preparation of Solid Electrolyte Layer

Sintered Li₇La₃Zr₂O₁₂ with a diameter of 11.2 mm and a thickness of 3.0 mm was prepared as a solid electrolyte layer. The denseness of the solid electrolyte layer was 97%.

### Preparation of Lithium Sulfur Secondary Battery

After loading 15.8 mg of powder containing lithium, sulfur, phosphorus and carbon into an alumina cylinder with a diameter of 11.28 mm and leveling it out, it was subjected to uniaxial compression molding for 3 minutes under a load of 10 kN to prepare a positive electrode active material layer.

The shut layer, the solid electrolyte layer, a Li foil with a diameter of 8 mm and a thickness of approximately 100 μm as the negative electrode active material layer, and a Cu foil with a diameter of 11.28 mm and a thickness of 15 μm as the negative electrode collector layer, were laminated in that order on the positive electrode active material layer in the cylinder. In addition, Al foil with a diameter of 11.28 mm and a thickness of 15 μm, as a positive electrode collector layer, was laminated on the positive electrode active material layer from the opposite side of the cylinder, to obtain a laminated battery. A load of 250 kgf was applied onto the laminated battery from the direction of lamination and clamped down on it to prepare a lithium secondary battery.

The lithium secondary battery prepared for Example 1 had the same construction as shown in FIG. 1.

### Comparative Example 1

After loading 300 g of Li₇La₃Zr₂O₁₂ powder with a mean particle diameter of 2 to 5 μm into an alumina cylinder (diameter: 11.28 mm) and leveling it, it was subjected to uniaxial compression molding for 3 minutes under a load of 60 kN to prepare a solid electrolyte layer.

An ionic liquid dissolving the lithium salt used for Example 1 was dropped onto the solid electrolyte layer in the cylinder, for vacuum impregnation for 1 minute under a pressure of 10 Pa. The excess liquid on the solid electrolyte layer was removed with a dropper.

After loading 15.8 mg of powder containing lithium, sulfur, phosphorus and carbon onto the solid electrolyte layer, it was subjected to uniaxial compression molding for 3 minutes under a load of 10 kN to prepare a positive electrode active material layer.

An Al foil with a diameter of 11.28 mm and a thickness of 15 μm, as a positive electrode collector layer, was laminated on the positive electrode active material layer in the cylinder. A Li foil with a diameter of 8 mm and a thickness of approximately 100 μm as the negative electrode active material layer, and a Cu foil with a diameter of 11.28 mm and a thickness of 15 μm as the negative electrode collector layer, were laminated in that order on the solid electrolyte layer in the cylinder, to obtain a laminated battery. A load of 250 kgf was applied onto the laminated battery from the direction of lamination and clamped down on it to prepare a lithium secondary battery.

The lithium secondary battery prepared for Comparative Example 1 had the same construction as shown in FIG. 2.

### <Measurement of Charge-Discharge Capacity>

### (Measuring Method)

The lithium secondary batteries of Example 1 and Comparative Example 1 were each subjected to a charge-discharge test at 60° C., with a current density of 45.6 μA/cm² and constant current. The maximum voltage during charge was 3.1 V, and the minimum voltage during discharge was 1.5 V.

### (Results and Evaluation)

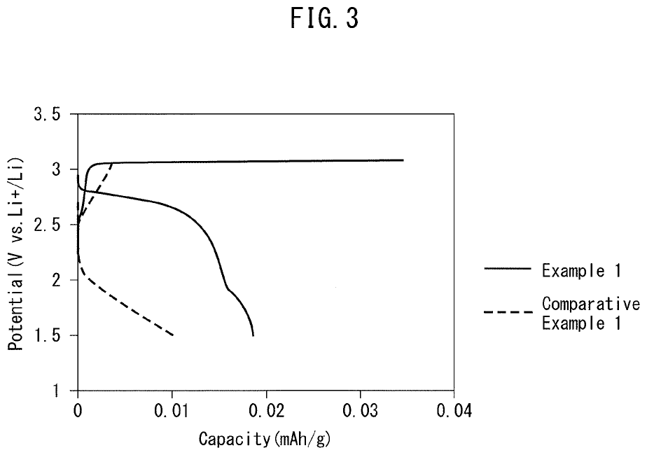

The measurement results are shown in FIG. 3.

FIG. 3 is a graph showing the charge-discharge capacities of the lithium secondary batteries of Example 1 and Comparative Example 1. As shown in FIG. 3, the lithium secondary battery of Example 1 had a higher discharge capacity than the lithium secondary battery of Comparative Example 1. The reason for the lower discharge capacity of the lithium secondary battery of Comparative Example 1 is presumed to be because the solid electrolyte layer contained an ionic liquid, whereby Li metal was inactivated at the interface between the solid electrolyte layer and the negative electrode active material layer during charge.

### Reference Examples 1 to 5

Electrolyte solutions dissolving 0.4 mol/L of lithium bis(trifluoromethanesulfonyl)imide (LiTFSI) as a lithium salt in N-methyl-N-propylpiperidinium bis(trifluoromethanesulfonyl)imide (PP13TFSI), 1-allyl-3-methylimidazolium bis(trifluoromethylsulfonyl)imide (AMIMTFSI), ethylene carbonate, propylene carbonate and tetrahydrofuran were prepared as Reference Examples 1 to 5, respectively, and the performance of each electrolyte solution was measured and evaluated by the following tests 1 to 3.

### <Test 1>

Lithium secondary batteries containing the electrolytes of Reference Examples 1 to 5 were fabricated as described below, and the charge-discharge capacities were measured to evaluate the lithium ion conductivity of each of the electrolyte solutions.

### (Fabrication of Battery)

### 1. Preparation of Positive Electrode Active Material Sheet

LiNi_{1/3}Co_{1/3}Mn_{1/3}O₂ as the positive electrode active material, Ketchen black as the conductive aid and polyvinylidene fluoride (PVDF) as the binder were mixed in a mass ratio of 90:5:5 to obtain a mixed powder. Next, N-methyl-2-pyrrolidone as a dispersing medium was mixed in a suitable amount with the mixed powder to obtain a positive electrode mixture slurry.

The positive electrode mixture slurry was coated onto an Al foil with a thickness of 15 μm as the positive electrode collector layer, to a basis weight of about 3 mg/cm², and dried, after which it was pressed with a roll press to a denseness of about 50%, to obtain a positive electrode active material sheet laminated on a positive electrode collector layer.

### 2. Preparation of Negative Electrode Active Material Sheet

Li₄Ti₅O₁₂ as the negative electrode active material, Ketchen black as the conductive aid and polyvinylidene fluoride (PVDF) as the binder were mixed in a mass ratio of 85:10:5 to obtain a mixed powder. Next, N-methyl-2-pyrrolidone as a dispersing medium was mixed in a suitable amount with the mixed powder to obtain a negative electrode mixture slurry.

The negative electrode mixture slurry was coated onto a Cu foil with a thickness of 15 μm as the negative electrode collector layer, to a basis weight of about 7 mg/cm², and dried, after which it was pressed with a roll press to a denseness of about 50%, to obtain a negative electrode active material sheet laminated on a negative electrode collector layer.

### 3. Preparation of Lithium Secondary Battery

A positive electrode active material sheet and negative electrode active material sheet prepared in the manner described above were punched to a diameter of 16 mm and a diameter of 20 mm, to obtain a positive electrode active material layer and a negative electrode active material layer. Coin cells were fabricated with the positive electrode active material layer, a porous resin film as a separator and the negative electrode active material layer laminated in that order, and the interiors of different cells were filled with the electrolytes of Reference Examples 1 to 6, respectively, to prepare lithium secondary batteries.

### (Charge-Discharge Test)

Each lithium secondary battery containing the electrolyte solution of one of Reference Examples 1 to 5 was subjected to 3 cycles of charge-discharge at a constant current of 4 mA, with a maximum voltage of 2.87 V and a minimum voltage of 1.5 V, in a thermostatic bath at 25° C., for measurement of the charge-discharge capacity. The measurement results are shown in Table 1, <Results and evaluation> below.

### <Test 2>

Lithium secondary batteries containing the electrolytes of Reference Examples 1 to 6 were fabricated as described below, and the charge-discharge capacities were measured to evaluate the reactivity of each electrolyte solution with lithium metal.

### (Fabrication of Battery)

Lithium secondary batteries containing the electrolyte solutions of Reference Examples 1 to 6 were fabricated in the same manner as above (Test 1), except that 20 μm-thick Ni foils punched to a 20 mm diameter were used instead of the negative electrode active material sheet and negative electrode collector layer.

### (Charge-Discharge Test)

The charge-discharge capacity of each of the electrolyte solutions of Reference Examples 1 to 6 was measured in the same manner as above (Test 1), except that the maximum voltage was 4.37 V and the minimum voltage was 3.0 V for charge-discharge. The measurement results are shown in Table 1 under <Results and evaluation> below.

### <Test 3>

Molded compacts of a sulfide solid electrolyte composed mainly of Li₃PS₄ were immersed in each of the electrolytes of Reference Examples 1 to 5, and after allowing them to stand for at least one week at ordinary temperature, the presence or absence of dissolution of the molded compacts of the sulfide solid electrolyte was evaluated by visual examination. The evaluation results are shown in Table 1 under <Results and evaluation> below.

### RESULTS AND EVALUATION

The measurement and evaluation results for Tests 1 to 3 are shown in Table 1.

TABLE 1

| | Sample | | | Results | | |
|---|---|---|---|---|---|---|
| | Electrolyte | | | Test 1*² | Test 2*² | |
| | solution*¹ | Type | LUMO | (mAh/g) | (mAh/g) | Test 3 |
| Reference Ex. 1 | PP13TFSI | Ionic liquid | −0.5099 | 138 | 0 | Insoluble |
| Reference Ex. 2 | AMIMTFSI | Ionic liquid | −2.274 | 131 | 23 | Insoluble |
| Reference Ex. 3 | Ethylene carbonate | Organic solvent | 1.2416 | 117 | 111 | Insoluble |
| | | | | | | (solution hardened) |
| Reference Ex. 4 | Propylene carbonate | Organic solvent | 1.3118 | 13 | 17 | Dissolved |
| Reference Ex. 5 | Tetraydrofuran | Organic solvent | −4.545 | 17 | Not done | Dissolved |

*¹Each electrolyte solution dissolved 0.4 mol/L LiTFSI as a lithium salt.
*²The results for Tests 1 and 2 list discharge capacities at the 3rd cycle.

As shown in Table 1, the lithium secondary batteries using the electrolyte solutions of Reference Examples 1 and 2 had discharge capacities of 138 mAh/g and 131 mAh/g, respectively, in Test 1. This indicates that the electrolyte solutions of Reference Examples 1 and 2 have lithium ion conductivity. Moreover, the lithium secondary batteries using the electrolyte solutions of Reference Examples 1 and 2 had very low discharge capacities of 0 mAh/g and 23 mAh/g, respectively, in Test 2. These results indicate that the electrolyte solutions of Reference Examples 1 and 2 reacted with the lithium metal precipitated on the Ni foils to produce electronic insulators.

Based on Tests 1 and 2, therefore, it may be concluded that the electrolyte solutions of Reference Examples 1 and 2 can each be used as a solution in a shut layer for a lithium secondary battery of the disclosure.

Moreover, the results of Test 3 indicate that the electrolyte solutions of Reference Examples 1 and 2 have low reactivity with sulfide solid electrolytes. Therefore, it may be concluded that the electrolyte solutions of Reference Examples 1 and 2 are preferred to be used when the lithium secondary battery of the disclosure comprises a sulfide solid electrolyte as the solid electrolyte.

In contrast, the lithium secondary battery using the electrolyte solution of Reference Example 3 had a discharge capacity of 117 mAh/g in Test 1, and had lithium ion conductivity. However, the lithium secondary battery using the electrolyte solution of Reference Example 3 had a discharge capacity of 111 mAh/g in Test 2. These results indicate that the electrolyte solution of Reference Example 3 did not react with the lithium metal precipitated on the Ni foil.

Based on Tests 1 and 2, therefore, it may be concluded that the electrolyte solution of Reference Example 3 cannot be used as a solution in a shut layer for a lithium secondary battery of the disclosure.

The electrolyte solutions of Reference Examples 4 and 5 had very low discharge capacities of 13 mAh/g and 17 mAh/g, respectively, in Test 1. These results indicate that the electrolyte solutions of Reference Examples 4 and 5 did not have sufficient lithium ion conductivity.

Therefore, it may be concluded that the electrolyte solutions of Reference Examples 4 and 5 cannot be used as solutions in a shut layer for a lithium secondary battery of the disclosure.

### REFERENCE SIGNS LIST

10 Positive electrode collector layer
20 Positive electrode active material layer
30 Separator layer
32 Shut layer
34 Solid electrolyte layer
40 Negative electrode active material layer
50 Negative electrode collector layer
100 Lithium secondary battery

1. A lithium secondary battery having a construction with a positive electrode active material layer, a separator layer and a negative electrode active material layer laminated in that order, wherein
the negative electrode active material layer comprises lithium metal,
the separator layer has a shut layer and one or more solid electrolyte layers,
one of the solid electrolyte layers is adjacent to the negative electrode active material layer, and
the shut layer comprises a lithium ion conductive liquid that reacts with the lithium metal to produce an electronic insulator.

2. The lithium secondary battery according to claim 1, wherein the lithium ion conductive liquid in the shut layer is held on a porous film.

3. The lithium secondary battery according to claim 1, wherein the lithium ion conductive liquid in the shut layer is in a gel state.

4. The lithium secondary battery according to claim 1, wherein the LUMO of the lithium ion conductive liquid is −0.50 eV or less.

5. The lithium secondary battery according to claim 1, wherein the lithium ion conductive liquid comprises an ionic liquid.

6. The lithium secondary battery according to claim 5, wherein a lithium salt is dissolved in the ionic liquid.

7. The lithium secondary battery according to claim 5, wherein the ionic liquid is N-methyl-N-propylpiperidinium bis(trifluoromethanesulfonyl)imide, butyltrimethylammonium bis(trifluoromethanesulfonyl)imide, N,N-diethyl-N-methyl-N-(2-methoxyethyl)ammonium bis(trifluoromethanesulfonyl)imide, 1-allyl-3-methylimidazolium bis(trifluoromethylsulfonyl)imide, triethylpentylphosphonium bistrifluoromethanesulfonylimide, 1-allyl-3-ethylimidazolium bis(trifluoromethanesulfonyl)imide, 1-allyl-3-butylimidazolium bis(trifluoromethanesulfonyl)imide, 1,3-diallylimidazolium bis(trifluoromethanesulfonyl)imide or 1-methyl-3-propylimidazolium bis(trifluoromethanesulfonyl)imide, or a combination thereof.

8. The lithium secondary battery according to claim 1, wherein the denseness of the solid electrolyte layer is 97% or greater.

9. The lithium secondary battery according to claim 1, wherein the solid electrolyte layer comprises a sintered oxide solid electrolyte.

10. The lithium secondary battery according to claim 1, wherein the positive electrode active material layer and/or the solid electrolyte layer comprises a sulfide solid electrolyte.

11. The lithium secondary battery according to claim 1, wherein the positive electrode active material layer comprises sulfur as a positive electrode active material.
